(19) United States
(12) Patent Application Publication
(10) Pub. No.: US 2003/0217076 A1
(43) Pub. Date: Nov. 20, 2003

(54) System and method for rapid generation of one or more autonomous websites

(76) Inventors: Christian Elliot Heptinstall, Ringgold, GA (US); Jeffrey Linn Parks, Cleveland, TN (US)

Correspondence Address: Edward J. Kondracki, Miles & Stockbridge P.C., Suite 500, 1751 Pinnacle Drive, McLean, VA, 22102, US

(21) Appl. No.: 10/382,850

(22) Filed: Mar. 7, 2003

Related U.S. Application Data
(60) Provisional application No. 60/380,284, filed on May 15, 2002.

(51) Int. Cl. G06F 7/00

(52) U.S. Cl. 707/104.1

(57) ABSTRACT

A system and method is provided for creating one or more autonomous websites wherein a default style sheet document is created that is common to one or more websites. Graphical content configured to be identified by a site-specific identifier are generated. The default style sheet document is manipulated to create a site-specific style sheet document to control the arrangement of the graphical content, the site-specific style sheet configured to be identified by the unique site-specific identifier. In a data repository at a managing location, an instance of each website is stored. Each instance comprises the unique site-specific identifier and a unique Universal Resource Locator (URL) so as to enable a configuration of the website adapted to be delivered over a network in response to a website request having a matching URL.

### RELATED APPLICATION

This application claims priority based on U.S. Provisional Patent Application Ser. No. 60/380,284, entitled “System and Method for Rapid Generation of a Plurality of Autonomous Websites,” filed on May 15, 2002.

### BACKGROUND OF THE INVENTION

The Internet has become the marketplace of the new economy. A key to success for a business using the Internet is the ability for a potential customer to find the products and services they are seeking on the Internet with a minimum of difficulty. Search engines are often a consumer's method of choice when searching for information on the Internet.

Just as in older modes of advertising, the more times a company name appears before a potential client, the more likely that a positive impression will be made and the probability that the potential client will become a paying customer will be greatly increased. Because search engines are one of the most widely used resources for locating products or services on the Internet, a company's existence or non-existence among the results of a search can often mean the difference between financial success and failure.

### SUMMARY OF THE INVENTION

The present invention addresses the aforementioned issues by providing a cost-effective method for an entity to appear one or more times in search engine results on a plurality of search engines. The present invention is a system and method for rapidly developing and deploying one or more autonomous websites without having to endure the high costs usually associated with the development thereof A single business may therefore have multiple websites appear in search engine results, thereby possibly increasing the number of website hits or page views from potential clients.

An advantage of the present invention is that a graphic designer does not need to understand HyperText Markup Language (HTML) in order to produce the highest quality work.

Another advantage of the present invention is that a graphic designer need only to place his/her work within the perimeters of a design interface and the present invention generates code to make a website. No HTML is written by a graphic designer or stored as a functioning website on a server. The final code is generated on-demand and on the fly in response to a request to view a website.

These and other advantages of the present invention will become readily apparent from a description of the various embodiments.

One embodiment of the present invention is a system and method for rapidly developing and deploying one or more autonomous websites. The method comprises the steps of

creating a default style sheet document common to the one or more websites;

generating graphical content configured to be identified by a site-specific identifier;

manipulating the default style sheet document to create a site-specific style sheet document to control the arrangement of the graphical content, the site-specific style sheet configured to be identified by the unique site-specific identifier; and

storing, in a data repository at a managing location, an instance of each website, each instance comprising the unique site-specific identifier and a unique Universal Resource Locator (URL) so as to enable a configuration of the website adapted to be delivered over a network in response to a website request having a matching URL.

Another embodiment of the present invention is a system and method for generating a webpage from one or more autonomous websites for delivery over a network comprising,

receiving a client header requesting to view a website from the network;

parsing the client header to extract a requested URL;

comparing the requested URL to a stored URL of an instance of each website in a data repository; and, upon determining a match,

assembling a webpage of the website associated with the matched instance by configuring content associated with the matched instance in a manner suitable for delivery over the network.

In the absence of a match, a default webpage or website is assembled.

### DETAILED DESCRIPTION OF THE FIGURES

In the drawings, where like reference numbers refer to like elements throughout the several views:

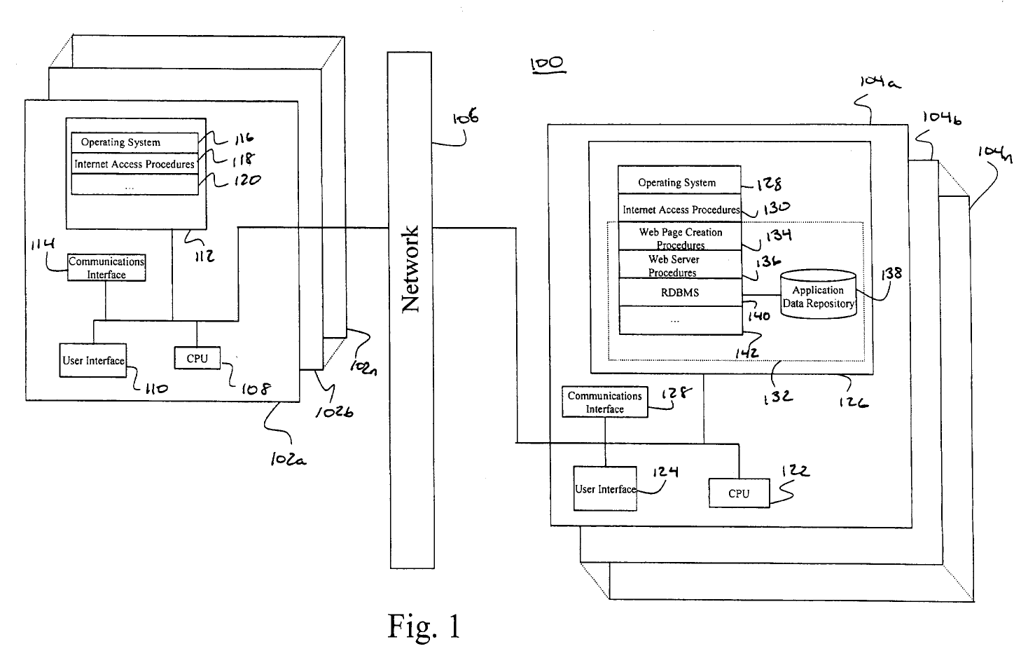

FIG. 1 shows a computer network environment in which one embodiment of the invention operates;

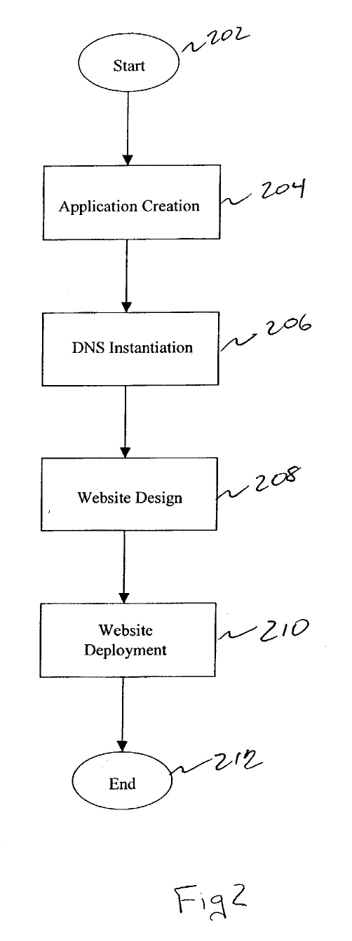

FIG. 2 is a flow chart showing a process for the generation of one or more autonomous websites in accordance with one embodiment of the present invention;

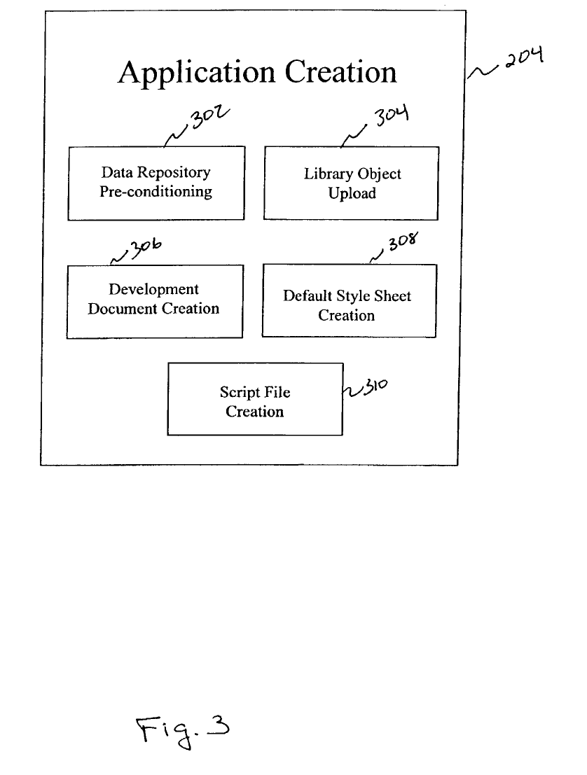

FIG. 3 is a block diagram showing a detail view of an application creation phase illustrated in FIG. 2;

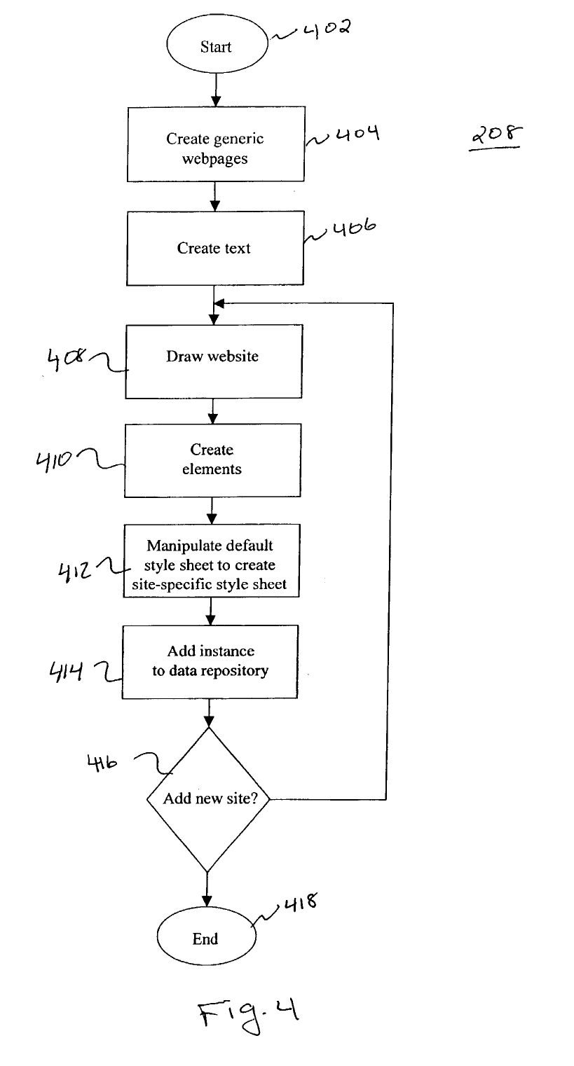

FIG. 4 is a flow chart showing a detail view of a website design phase illustrated in FIG. 2;

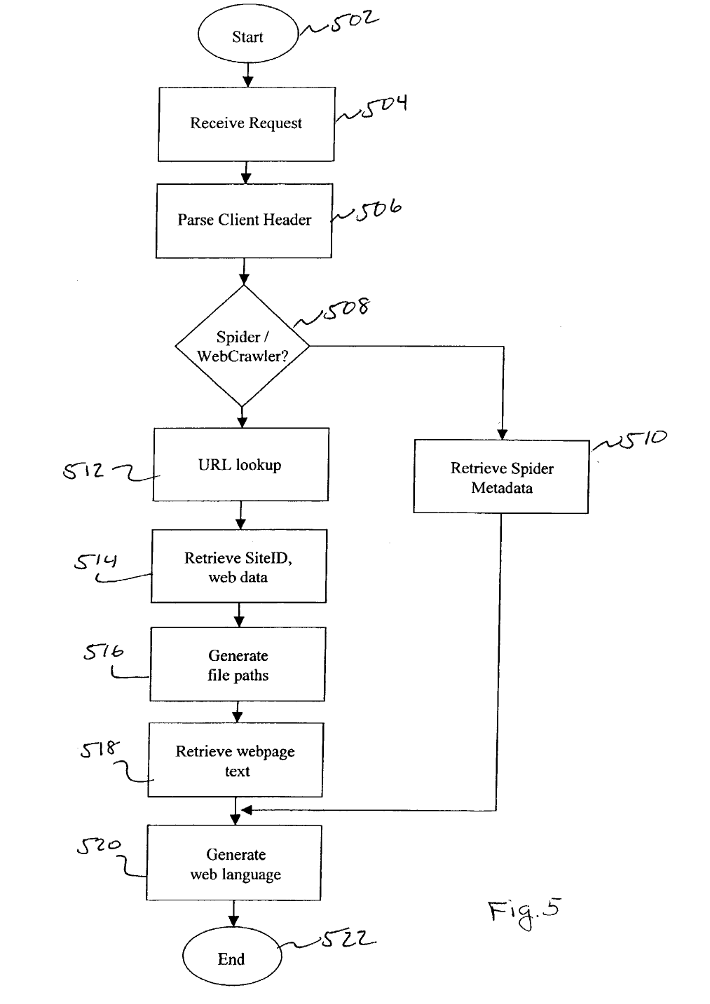

FIG. 5 is a flow chart showing control flow for assembling a webpage for display in accordance with one embodiment of the present invention; and,

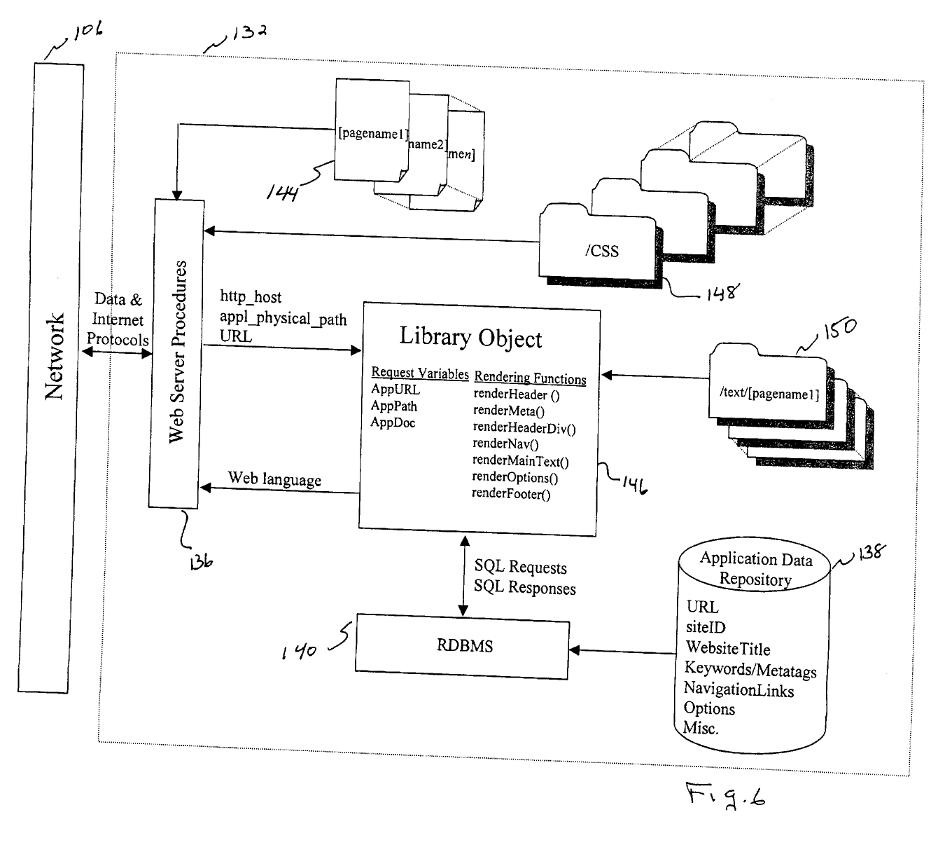

FIG. 6 is a block diagram showing data flow for the assembling of a webpage for display in accordance with one embodiment of the present invention.

### DETAILED DESCRIPTION OF THE INVENTION

FIG. 1 illustrates a system 100 assimilating an embodiment of the present invention including a number of client computers 102a . . . 102n and one or more server computers 104a . . . 104n each in communication via a communications link 106.

The communication link 106 generically can be any type of wire or wireless link between computers, such as a global computer network like the Internet. Although the present invention is designed for the Internet, it may be used on any network supporting Internet protocols such as a wide area network, a local area network, or a combination of networks.

Client computer 102 can be any type of computing device, such as, but not limited to, a desktop computer, workstation, laptop, Wireless Application Protocol (WAP) device, and/or mainframe computer. One or more users (not shown) can be associated with each client computer 102.

Each client computer 102 includes a central processing unit (CPU) 108, a user interface 110, a memory 112, and a communication interface 114. Communications interface 114 is used to communicate with server computer 104 as well as other system resources of the type well known in the art but not shown. Memory 112 of client computer 102 may be implemented as random access memory (RAM) or a combination of RAM and non-volatile memory such as magnetic disk storage. Memory 112 can contain the following:

an operating system 116;

Internet access procedures 118;

as well as other procedures and files 120.

Server computer 104 includes a CPU 122, a user interface 124, a memory 126, and a communications interface 128. Server computer 104 can be any type of computing device, such as but not limited to, a server computer, desktop computer, workstation, laptop, WAP device, and/or mainframe computer. Communication interface 118 is used to communicate with client computers 102 as well as other system resources of the type well known in the art but not shown.

Memory 126 may be implemented as RAM (random access memory) or a combination of RAM and non-volatile memory such as magnetic disk storage. Memory 126 can contain the following:

an operating system 128;

Internet access procedures 130; and

a web hosting system 132 comprising the following:

web page creation procedures 134 that dynamically generate web pages in response to requests from client computer 102;

web server procedures 136 that configure a web page for delivery over network 106 to client computer 102;

an application data repository 138 for storing website data relating to the dynamic assembly of a website;

a relational database management system (RDBMS) 140 for managing queries and data information flow to and from data repository 138; and

other procedures and data structures 142.

It should be appreciated that for explanatory and clarification purposes, data repository 138 is referenced as a single element in the present embodiment. It is important to note that any number of data repositories may maintain website data.

Web services 136 of web hosting system 132 resides at one or more target IP addresses in cooperation with the Domain Name System (DNS), an Internet service that translates domain names into IP addresses. The significance of this cooperation will be appreciated upon further disclosure of the present invention.

FIG. 2 shows a flow chart depicting a method for the rapid generation of one or more autonomous websites in accordance with one embodiment of the invention. The method generally comprises four phases: an application creation phase 204, a DNS instantiation phase 206, a website design phase 208, and a website deployment phase 210.

The method begins at block 202 and proceeds to application creation phase 204, wherein a site architect preconditions web hosting system 132 so that a graphic designer is not required to program or manipulate the file and folder structure. Application creation phase 204 will be described in further detail with reference to FIG. 3.

One or more domain names are registered to a DNS server at DNS instantiation phase 206. Each website has a unique URL, the global address of documents and other resources on the World Wide Web that includes a domain name in its address. A standard DNS record refers a proper URL to a specific Internet Protocol (IP) address where an application is hosted. A standard DNS record includes a top-level domain (“.com”, “.net”, “.org”, etc.), a second-level domain which is often referred to simply as the domain name itself (“mycompany”), and a third level domain (most commonly “www” but can be nearly any string). While it is only necessary to register one domain name, it is particularly beneficial to register multiple domain names when a large number of websites are to be deployed. Multiple domain names will generate multiple listings in search engine results, thereby multiplying the marketing effectiveness of the present invention.

At website design phase 208, one or more graphic designers create one or more websites. Because the graphic designers draw each website using a graphic editor, they are not required to be familiar with web languages such as HTML, or any web scripting languages. Since the site architect implements any preconditioning of web-hosting system 132 at previous phase 204, the graphic designers are permitted to focus on site graphics and aesthetic design. Website design phase 208 will be described in further detail with reference to FIG. 4.

At website deployment phase 210, the one or more websites is finally deployed by submitting each URL to any number of search engines for indexing and ultimate inclusion in search results. The method ends at block 212. It should be appreciated that the order in which the phases are depicted and described herein is just one embodiment, and alternative embodiments may vary.

FIG. 3 is a detail view of application creation phase 204. Application creation phase 204 comprises five steps including a data repository preconditioning step 302, a library object upload step 304, a development document creation step 306, a default style sheet creation step 308, and an optional script file creation step 310. As depicted in FIG. 3, each of these steps may be implemented in any sequence.

Data repository preconditioning step 302 preconditions data repository 138 via RDBMS 140 for storing website data for each of the one or more of websites. Within repository 138, website data including all URLs, metadata, and website configurations are stored and eventually retrieved for dynamically assembling each website. Repository 138 is preconditioned to receive an instance of each website which may or may not include the following:

1. URL—The unique URL of the website.

2. Site Identifier—A unique website identifier for the website.

3. Metadata—Keywords and metatags associated with the website.

4. Navigation Structure—A multi-dimensional array holding information for hyperlinks of the site, said multiple dimensions containing the name of the link, the title of the link, and the target of the link, as well as optional titles and other properties.

5. Option Values—A multi-dimensional array holding information for mouseover options on the site, said multiple dimensions containing the name of the image, and the text or target of the option, as well as optional titles and properties.

6. Miscellaneous—A Boolean indicator signifying the presence or absence of any other website functionality. For example, a value of “True” may indicate the existence of an external script file containing code for additional functionality such as a Java popup menu or an applet.

It should be appreciated that the information stored in the data repository is not limited to nor constrained by the above data or data repository design. In other embodiments, the multi-dimensional arrays may alternatively be implemented as independent data tables so that more than one website may be associated with the same navigation or mouseover options. It should further be appreciated that each instance of a website may contain unique or cloned data of another website, with the exception of the unique site identifier and unique URL, so that the method of producing one or more websites is still more efficient.

In the present embodiment, library object upload step 304 comprises uploading to hosting system 132 and storing in memory 126 of server 104 a library object. The library object is a pre-built, self-contained library of variables and executable functions. These functions are responsible for retrieving the appropriate website data from repository 138, and generating file paths for web content so that it may be rendered to a webpage using a web language, such as for example, HTML or eXtensible HTML (xHTML). The library object includes a number of request variables which are set to parameter values, including the requested URL from network 106. The library object includes a number of rendering functions that generate a web language string incorporating values corresponding to the associated website data and content. Because the library object is self-contained code, it may be ported to any number of servers 104. Also, the self-contained code is portable across multiple hosting systems 132, so that a generic library object may be used for different website hosting applications. The architecture of the library object may vary among platforms, including a Component Object Module (COM+) Dynamic Link Library (DLL), or a JavaBean, or any other library object.

Development document creation step 306 includes the creation and upload of a development-only webpage document that renders a complete webpage, including text, HTML divisions, and/or file paths for images. The development document invokes the library object and makes functions calls to its rendering functions. The rendering functions return web language code to the development document for displaying a webpage. Accordingly, the development document may be any document supporting a scripting language including, but in no way limited to, an Active Server Page (ASP), an ASP+ page, a Hypertext PreProcessor (PHP) page, etc.

The development web page document serves to benefit the graphic designer in the subsequent website design phase 208 by providing the ability to preview the dynamic assembly of the web content as viewed through a web browser. The graphic designer can thus determine what modifications, if any, should be applied to the graphic during design phase 208.

The default style sheet creation step 308 includes creating the default style sheet document. This default style sheet comprises element definitions that define the existence of various elements common to the one or more websites, but is void of any values. Elements may include body text, navigation elements, header elements, or any other elements the site architect designs across the one or more websites. Each element definition is identified by a unique element name incorporating an element identifier. For example, the default style sheet may define a #navdv2 element as follows:

#navdv2 {}

The #navdv2 element refers to the second element of the navigation division of a website, whose image would be created at graphic design phase 208. As shown, the #navdv element definition is void of any values when defined in the default style sheet.

The value of using a style sheet in accordance with the present invention should be well noted. Because style sheets provide a means of associating presentational information with the web elements, the underlying structure of each website will not be affected. By having each webpage of a website referencing the same style sheet, the presentation format cascades to all webpages of that site. Using different style sheets for multiple websites can dramatically alter the “look and feel” among websites while dynamically assembling identical content. The value of this feature will become even more apparent upon further disclosure of the invention.

The default style sheet may be a Cascading Style Sheet (CSS), eXtensible Style Language Transformation (XSLT), or any other style sheet for webpages. Visual InterDev or any other style sheet editor may be utilized to create the default style sheet. It should be appreciated that one or more default style sheet's may be used in creating the one or more websites.

A dedicated external script file is created at script file creation step 310 to allow common access to general functions. The library object, or script page, accesses this external script file as determined by the Boolean indicator in data repository 138. There is no limit to the type of functionality which may be coded in the script file for the websites.

FIG. 4 shows a detail view of graphic design phase 208 of FIG. 2. Phase 208 begins at step 402 and proceeds to step 404, where a plurality of webpages necessary for the final sites is created. The webpages are generally identical, each invoking a library object. However, each webpage bears a unique, descriptive name, such as for example home.asp or contacts.asp. The webpages may be any document that is viewable in a web browser or deliverable over a network for view in a web browser. In contrast to the development document, these webpages are used in hosting the one or more websites.

The webpages are common to each website and are generic in the sense that they serve as the rudimentary documents to which dynamic content of the websites is directed. Therefore, each autonomous website builds the dynamic content to a common set of webpages. In this manner, only the coded structure of each of the websites is required to be identical, whereas web content, formatting, and positioning is permitted to vary site by site. Each website may be unique, since the web content is dynamically assembled within each webpage in accordance with each particular website's directives.

For each web page created at step 404, a text document is created at step 406 that contain the portion of text that will be viewable by client computer 102. Several versions of text are written, wherein each version comprises one text document for each webpage created at step 404. Multiple websites may display the same version of text, thereby eliminating the need to author a large number of narratives or generate a large number of text documents for the websites. For example, there may be one thousand websites sharing only nine versions of text.

In the present embodiment, an appropriate file structure exists so that each text document may be uniquely identified and displayed on a webpage. Each version of text is assigned a unique version identifier, and every text document incorporates the version identifier according to the version to which it belongs into its filename. A text folder corresponds to each webpage created at step 404, each folder containing all versions of text for display on that respective page. For example, C:\wwwroot\text\home\07.txt may be the file path of version 7 text for a home.asp webpage.

At step 408, one or more graphic designers create each website's images on a site-by-site basis. A site is custom created as images using an image editor of the graphic designer's choice. One or more images are created for a common display on all of the webpages of a website. The images, in combination with a text document, constitute the display for a webpage. It should be appreciated that any image editor may be utilized, such as Adobe Photoshop.

At step 410, the designer cuts the whole of a single image into smaller pieces that correspond to the element definitions in the default style sheet. The elements are destined to be reconstructed dynamically upon visitor actuation and become content in a completed, visited website. This content includes aesthetic elements, navigation links, header graphics, option graphics, etc. Each element is assigned a unique identifier, wherein the first section is specific to the site and the final digit is specific to the element. For example, the graphic designer may save the Home button element of a navigation bar as 105_{—}2.gif, where the Home button is identified as the number 2 navigation element of the number 105 site. Each element is uploaded to web hosting system 132. The image elements may be stored in a parent-child file structure, wherein child elements belonging to the same parent element as defined by the style sheet are stored in the same folder. For example, all navigation bar elements of all of the websites may be stored in the same navigation folder, wherein C:\wwwroot\nav\105_{—}2.gif is the file path for the second image element of the navigation division of the website with site identifier 105. However, it should be appreciated that such an identifying scheme may vary in other embodiments.

For each website, the graphic designer manipulates a copy of the default style sheet using a Graphical User Interface (GUI) to create a site-specific style sheet at step 412. Unlike the default style sheet, the site-specific style sheet holds values that attend to the formatting and positioning of the images and text.

The graphic designer provides a request to the development document for previewing the website under creation. The development document, which invokes the library object having rendering functions, dynamically generates web language to set each element for displaying the website in accordance with the copy of the default style sheet. The copy is manipulated, with the graphic designer adding values for the x, y, and z coordinates of the elements to create the new, site-specific style sheet for arranging into a pixel perfect website. For example, the #navdv2 element defined in the default style sheet of the previous example may now contain values as shown below:

#navdv2 {
Z-INDEX: 40;
LEFT: 300px;
POSITION: absolute;
TOP: 76px; }

Text formatting, background colors, and other aesthetic modifications may be made to the site-specific style sheet. The site-specific style sheet is stored to memory 132. The site-specific style sheet is named a unique identifying file name, such as 105.css for the website with site identifier 105, but it should be appreciated that the file name may vary in alternative embodiments.

At step 414, an instance of the website is added to data repository 138 via RDBMS 140, including the unique URL, unique site identifier, metadata, navigation structure, option values, or other web data. This task may be completed directly through RDBMS 140, or may alternatively use a special administrative module that communicates with RDBMS 140 or repository 138.

Such a module may be accessible over the Internet, such as by adding /admin to the URL of the site to be modified, and possibly combined with an administrative password. Upon access to the module, the graphic designer creates an instance for the new website by adding the web data. Also from the module, the graphic designer can modify an existing website already created in data repository 138. After choosing a site to be edited, the graphic designer claims ownership of changes to that site, or in the case the site has just been created, ownership of the site itself, by selecting his/her name from a menu in the administration module and optionally entering a name in an appropriate field. Clicking on a submit button or other action makes all changes needed to the database record, thereby updating the website content. It should be appreciated that the administrative module may also act as the GUI for manipulating the default style sheet for creating the site-specific style sheet, thereby providing a central location for managing the structural integrity and/or aesthetics of the one or more websites.

If the graphic designer wishes to add a new site to hosting system 132 at decision block 416, the process is repeated by drawing a new website at step 408. If, however, the graphic design of the one or more websites is completed, the process ends at step 418.

FIGS. 5 and 6 depict control flow and data flow, respectively, of system 132 in response to a request for a webpage from network 106. The process begins at block 502 and the request is received at block 504 by web services 136. In accordance with standard Internet protocols, web services 136 directs the request to the appropriate webpage or webpages 144. For example, if the requested URL is www. anydomain.com/home.asp, then the home.asp webpage of webpages 144 is directed the request.

Upon receiving a request at a webpage 144, a web scripting language is used to access and parse predetermined environment variables within the request's client header. Library object 146, which is invoked on webpages 144, retains three of these environment variables from the client header at block 506. The first variable is the HTTP_HOST variable, which returns a string containing information about the requesting client. The information may include an IP address, a DNS name, or a user agent of the requesting host. The second variable is the APPL_PHYSICAL_PATH variable, which returns a string of the physical path of the requested webpage on server 104. The third variable is the URL variable, which returns the base portion of the requested URL. In the present embodiment, the first, second, and third variables are retained by library object 146 as AppURL, AppPath, and AppDoc, respectively.

With the environment variables now retained, library object 146 determines, at block 508, the origin of the client request by examining the AppURL variable by comparing the string to a list of known web crawlers or spiders, which crawl the World Wide Web for indexing websites and webpages for search engines.

If it is determined that the origin of the request is a web crawler or spider, then library object 146 retrieves a special group of text designed to achieve top ranking in search engine relevancy ratings at block 510 from a text file or database. This special text is a combination of keywords and meta-information. When a search is performed, the search engine can display the URL and its associated meta-information in the search engine results. The text is passed to web services 136 by library object 146 at block 520 using a metadata rendering function. The metadata rendering function returns a web language string to the requested webpage comprising the page metadata. Web services 136 subsequently responds to the request over network 106 in accordance with Internet protocols, and the process ends at block 522.

If, however, the origin of the request is not determined to be a web crawler or spider, then control flow passes to block 512, wherein library object 146 issues requests to RDBMS 140 for comparing the URL of the AppDoc variable to data repository 138. When a match for the URL is found, the site identifier and other web data relevant to the formatting of the website and its content is received and retained as a variable(s) of library object 146 at step 514. In the absence of a match, a default website or webpage is assembled. In the present embodiment, Standardized Query Language (SQL) facilitates communication between library object 146 and RDMBS 140. It should be appreciated that any query language may be employed.

At step 516, library object 146 generates directory/file paths to site-specific content 148, including the site-specific style sheet and images, using a combination of the AppPath variable and the unique site identifier retained at step 514. For example, if the AppPath variable comprises the string C:\wwwroot\mycompany\, and the unique site identifier is 105, then library object 146 generates the directory/file path for the site-specific style sheet as C:\wwwroot\CSS\105.css. Similarly, library object 146 generates the directory/file path for the third image element of the navigation bar of the website as C:\wwwroot\nav\105_{—}3.gif.

At step 518, library object 146 retrieves text from text documents 150. There are numerous methods for determining the version of text to be displayed on a website. One such method calculates a modulus from a mathematical division of the total number of existing text versions by the unique site-identifier. The modulus is then used as the determinant version number. Another method may rotate through the versions of text, or alternatively, randomly select a version. Text documents 150 are read and text is retained as a variable(s) of library object 146.

The requested webpage is assembled at block 520 by configuring the image content and web data in a manner suitable for delivery over network 106. Pieces of previously designed, hard-coded HTML or any other web language are assembled by library object 146 and appropriate values are inserted within this code where necessary. These values include text, web data from repository 138, as well as directory/file paths for images, the site-specific style sheet, of additional script files. The code, now incorporating these values, is complete for delivery to network 106. The code is sent as a web language string to web server procedures 136 for assimilation onto the requested webpage 144. In the case of missing navigation images, library object 146 is capable of generating text hyperlinks to maintain the navigation structure of the website. Upon delivery over network 106, requesting client 102 can view the website just as any conventional website. The process ends at block 522.

It is important to note that a website may be actuated either directly, for example typing in the URL into a web browser, or indirectly as a link from a search engine's result list. In the latter case, search engines will often append additional data to the URL, such as the keywords submitted to the search engine for searching. In one embodiment of the present invention, there is the option of altering the keywords, title or description of a website based on either a portion or the whole of the URL and/or a GET variable attached to the end of a requested URL. That portion of the URL may be parsed by a web scripting language from the client header and retained as a variable by library object 146. This has the ability to multiply the effectiveness of a single website by several fold and multiple web sites by as much a margin.

The following is an example:

Requested URL received from network 106:

http://www.anydomain.com/?key=Red % 20Cars&des=Red % 20Cars %for % 20Personal % Use

or

http://red-cars.anydomain.com/?des=Red % 20Cars % for % 20Personal % Use

Returned code to web services 136, incorporating specific keywords and metadata from the requested URL:

<html>
<title>Red Cars</title>
<head>

<meta name= “keywords” content= ” Red Cars”>
<meta name= “description” content= ” Red Cars for Personal Use”>

</head>
[HTML Code]
</html>

While the above description utilizes a library object for implementing rendering function and variables, it should be appreciated that the utilization of a library object is merely one embodiment of the invention. Alternatively, the library object may be substituted with server-side scripting, client-side scripting, other programming languages, a compiled executable, or other methods. There are various advantages associated with each. In one such embodiment, an Active Server Page (ASP) document may support server-side scripting functions for processing request variables or rendering functions for retrieving and assembling the website. Scripting languages may include ECMA-262, jscript, JavaScript, PERL, and/or VBscript, or any other web language. For the purpose of simplification, a library object was utilized in the description of the above embodiments but in no way is meant to be limiting. It will be readily apparent to those familiar in the art that substitute methods of implementation for the library object are both abundant and obvious.

While this invention has been described in conjunction with specific embodiments thereof, it is evident that many alternatives, modifications and variations will be apparent to those skilled in the art. Accordingly, the preferred embodiments of the invention as set forth herein, are intended to be illustrative, not limiting. Various changes may be made without departing from the true spirit and full scope of the invention as set forth herein and defined in the claims.

1. A method for generating a webpage from one or more autonomous websites for delivery over a network comprising the steps of:
receiving a client request to view a website from the network;
parsing the client request to extract a requested Universal Resource Locator (URL);
comparing the requested URL to a stored URL of an instance of each website in a database; and, upon determining a match between the requested URL and the stored URL,
assembling a webpage by configuring content associated with the matched instance in a manner suitable for delivery over the network.

2. The method of claim 1, wherein the stored URL is unique among the one or more websites.

3. The method of claim 1, wherein the content includes navigation structure data, text, images, or a combination thereof.

4. The method of claim 1, wherein the parsing step further comprises extracting a segment from the requested URL, and the step of assembling further comprises altering content of the website according to the extracted segment.

5. The method of claim 1, wherein the assembling step is performed by a library object.

6. The method of claim 1, wherein the assembling step is performed by a scripting language.

7. A method for creating one or more autonomous websites comprising the steps of:
creating a default style sheet document common to the one or more websites;
generating graphical content configured to be identified by a site-specific identifier;
manipulating the default style sheet document to create a site-specific style sheet document to control the arrangement of the graphical content, the site-specific style sheet configured to be identified by the unique site-specific identifier; and
storing, in a data repository at a managing location, an instance of each website, each instance comprising the unique site-specific identifier and a unique Universal Resource Locator (URL) so as to enable a configuration of the website adapted to be delivered over a network in response to a website request having a matching URL.

8. The method of claim 7, further comprising the step of creating one or more webpages common to the one or more websites.

9. The method of claim 8, further comprising the step of creating one or more text versions, each text version comprising one or more text documents corresponding to the one or more webpages, each text document having text for presentation on the corresponding webpage.

10. The method of claim 7, wherein the instance of a website further comprises navigation data.

11. The method of claim 7, wherein the instance of a website contains unique or cloned data of another instance of the data repository.

12. A computer readable medium having stored thereon one or more sequences of instructions for causing one or more microprocessors to perform steps for:
receiving a client request from a network to view a website of one or more autonomous websites;
parsing the client request to extract a requested Universal Resource Locator (URL);
comparing the requested URL to a stored URL of an instance of each website in a database; and, upon determining a match between the requested URL and the stored URL,
assembling a webpage by configuring content associated with the matched instance in a manner suitable for delivery over the network.

13. The computer readable medium of claim 12, wherein the stored URL is unique among the one or more websites.

14. The computer readable medium of claim 12, wherein the content includes navigation structure data, text, images, or a combination thereof.

15. The computer readable medium of claim 12, wherein the parsing step further comprises extracting a segment from the requested URL, and the step of assembling further comprises altering content of the website according to the extracted segment.

16. A system for generating a webpage from one or more autonomous websites for delivery over a network comprising:
a memory configured for storing an instance for each website, each instance comprising a unique website identifier and a Universal Resource Locator (URL); and
a processor configured to execute the steps of:
receiving a client request to view a website from the network;
parsing the client request to extract a requested URL;
comparing the requested URL to a stored URL of the instance of a website; and, upon determining a match between the requested URL and the stored URL,
assembling a webpage by configuring content associated with the matched instance in a manner suitable for delivery over the network.

17. The system of claim 16, wherein the stored URL is unique among the one or more websites.

18. The system of claim 16, wherein the content includes navigation structure data, text, images, or a combination thereof.

19. The system of claim 16, wherein the parsing step further comprises extracting a segment from the requested URL, and the step of assembling further comprises altering content of the website according to the extracted segment of the requested first URL.

20. The system of claim 16, wherein the assembling step is performed by a library object.

21. The system of claim 16, wherein the assembling step is performed by a scripting language.

22. A computer readable medium having stored thereon one or more sequences of instructions for causing one or more microprocessors to perform steps for:
creating a default style sheet document common to one or more websites;
generating graphical content configured to be identified by a site-specific identifier;
manipulating the default style sheet document to create a site-specific style sheet document to control the arrangement of the graphical elements, the site-specific style sheet configured to be identified by the unique site-specific identifier; and
storing, in a data repository at a managing location, an instance of each website, each instance comprising the unique site-specific identifier and a unique Universal Resource Locator (URL) so as to enable a configuration of the website adapted to be delivered over a network in response to a website request having a matching URL.

23. The computer readable medium of claim 22, further comprising the step of creating one or more webpages common to the one or more websites.

24. The computer readable medium of claim 23, further comprising the step of creating one or more text versions, each text version comprising one or more text documents corresponding to the one or more webpages, each text document having text for presentation on the corresponding webpage.

25. The computer readable medium of claim 22, wherein the instance of a website contains unique or cloned data of another instance of the data repository.

26. The computer readable medium of claim 22, wherein the instance of a website further comprises navigation data.

27. A system for creating one or more autonomous websites comprising:
a memory configured to store a data repository;
a processor configured to execute the steps of:
creating a default style sheet document common to the one or more websites;
generating graphical content configured to be identified by a site-specific identifier;
manipulating the default style sheet document to create a site-specific style sheet document to control the arrangement of the graphical content, the site-specific style sheet configured to be identified by the unique site-specific identifier; and
storing, in the data repository at a managing location, an instance of each website, each instance comprising the unique site-specific identifier and a unique Universal Resource Locator (URL) so as to enable a configuration of the website adapted to be delivered over a network in response to a website request having a matching URL.

28. The system of claim 27, further comprising the step of creating one or more webpages common to the one or more websites.

29. The system of claim 28, further comprising the step of creating one or more text versions, each text version comprising one or more documents corresponding to the one or more webpages, each text document having text for presentation on the corresponding webpage.

30. The system of claim 27, wherein the instance of a website further comprises navigation data.

31. The system of claim 27, wherein the instance of a website contains unique or cloned data of another instance of the data repository.
